(19) United States
(12) Patent Application Publication
(10) Pub. No.: US 2026/0227962 A1
(43) Pub. Date: Aug. 6, 2026

(54) TECHNIQUES FOR PROCESSING CODE BY MEANS OF MACHINE LEARNING MODELS

(71) Applicant: Robert Bosch GmbH, Stuttgart (DE)

(72) Inventors: Jesko Hecking-Harbusch, Leonberg (DE); Jochen Quante, Ludwigsburg (DE); Martin Leinberger, Koblenz (DE); Matthias Woehrle, Bietigheim-Bissingen (DE)

(21) Appl. No.: 19/323,287

(22) Filed: Sep. 9, 2025

(30) Foreign Application Priority Data
Sep. 11, 2024 (EP) 24 19 9781.6

(51) Int. Cl. G06F 8/30; G06N 3/08

(52) U.S. Cl. CPC G06F 8/30; G06N 3/08

(57) ABSTRACT

A method for editing program code using a machine learning model. The method includes accessing an original code and replacing elements of the original code with replacement elements to obtain a modified code. The replacement elements are shorter than the corresponding elements of the original code. The method further includes processing the modified code using a machine learning model.

### BACKGROUND INFORMATION

In recent times, machine learning models and in particular language models have found their way into numerous applications for generating and processing program code. For example, program code can be improved, annotated, or translated from a first programming language into a second programming language.

In this context, it may be necessary to use as large a portion of the program code as possible as input to the machine learning model. For example, a portion of the program code can be incorporated into a request (e.g., a prompt) to a large language model (e.g., to translate the program code from a first programming language into a second programming language). A maximum length of the request may be too short to transfer the desired portion at once to the large language model and process it.

The techniques of the present disclosure are directed to solving this problem.

### SUMMARY

A method according to a first aspect of the present invention relates to a method for editing program code by means of a machine learning model. The method comprises accessing an original code and replacing elements of the original code with replacement elements to obtain a modified code. The replacement elements are shorter than the corresponding elements of the original code. The method further comprises processing the modified code by means of a machine learning model.

A second aspect of the present invention relates to a method for training a machine learning model to edit program code. The method comprises accessing a machine learning model and accessing two or more modified codes. Each modified code is generated from an original code by replacing elements of the original code with replacement elements. The replacement elements are shorter than the corresponding elements of the original code. The replacement elements for each of the modified codes differ from one another at least partially. The method further comprises separately processing the two or more modified codes by means of a machine learning model and adapting the machine learning model on the basis of an analysis of a result of the processing of the two or more modified codes by the machine learning model.

A third aspect of the present invention relates to an environment configured to carry out one of the methods of the first or second aspects of the present invention. The environment can be a development environment for program code.

A fourth aspect of the present invention relates to a computer program containing instructions that, when executed by a computing unit, cause the computing unit to carry out a method for editing program code by means of a machine learning model according to the first aspect of the present invention or a method for training a machine learning model to edit program code according to the second aspect of the present invention.

The techniques of the first to fourth aspects of the present invention can have one or more of the following advantages in some implementations.

First, thanks to the techniques of the present invention, it may be possible to process longer portions of program code by means of machine learning models (e.g., large language models). In some examples, the original code contains identifiers, e.g., for variables or functions, that are of considerable length. In order to process the identifiers with the machine learning model, it may be necessary to decompose them into a series of symbols. An example of this are the tokens of a large language model, i.e., words or parts of words into which a text is decomposed. For example, the variable name “rbg_VSSWiperCtrl_stLSSCar” can contain twelve tokens of a typical large language model. This means that the limited number of tokens that can be processed in a request by the large language model is reached relatively quickly. As a result, the length of the processable program code can be significantly limited. The techniques of the present disclosure replace elements of the original code with shorter replacement elements (e.g., the variable name “rbg_VSSWiperCtrl_stLSSCar” with the replacement name “a”). This can reduce the number of symbols (e.g. tokens) without changing the structure of the program code. This allows the machine learning model to process the modified program code in the same way as the original code. However, a longer program code can be processed in a single request.

Secondly, and as a consequence, the quality and/or speed of the processing of the program code can be increased in some examples by means of machine learning models (e.g., large language models). For example, a translation of program code from a first programming language into a second programming language can in some cases be improved by processing a longer program code in one request. In large language models, for example, this can be due to the fact that the large language model uses the entire request as the context for processing, but cannot consider program parts outside the request as context. This can reduce processing quality because relevant information sometimes lies outside the included context. The same applies to other processing types discussed in the present disclosure.

Some terms used in this disclosure are explained below.

“Program code” (also referred to as “code” for short) can contain instructions for a specific computer program or a part thereof that describe or represent its functionality in a specific programming language.

The program code of the present disclosure can be at least a part of software (software component) for any technical device designed to solve a specific technical problem. For example, software of a computing unit (e.g., a control unit) can contain or be based on program code generated and/or processed by means of the techniques of the present invention, possibly after one or more processing steps such as compilation. Further specific examples are given below.

A “system” of the present disclosure may be any technical device designed to solve a specific technical problem. A system can comprise software and/or hardware components (or consist of one or more of these components). A system can comprise a computing unit or be designed to be executed on a computing unit. For example, a system can be a computing unit (e.g., a control unit) with corresponding programming (i.e., the system can contain program code that at least partially defines its functionality; this program code can be the program code generated and/or processed by means of the techniques of the present invention or can be based on said code, possibly after one or more processing steps such as compilation). Further specific examples are given below.

A “machine learning model” can be any model that is trained or is being trained to process program code by means of machine learning techniques. In some examples, the machine learning model can be a generative machine learning model, e.g., a generative foundation model. In some examples, the machine learning model can comprise a language model or a model for language generation. For example, the machine learning model can comprise a large language model. The machine learning model can be based on an existing (trained) generative machine learning model and adjusted (e.g., by further training and/or fine-tuning) with one or more of the techniques described below for use in the methods of the present disclosure. For example, the generative machine learning model can comprise one or more of CodeLlama, Llama, Mistral, CoPilot and/or language models from the GPT family (for example, ChatGPT). In other examples, multi-modal models such as Gemini, GPT4o can be used.

### BRIEF DESCRIPTION OF THE DRAWINGS

FIG. 1 illustrates example methods of the present invention. The left-hand column shows a flowchart of a method for training a machine learning model to edit program code according to the present invention. The middle column shows a flowchart of a method for editing program code by means of a machine learning model according to the present invention. The right-hand column shows a flowchart of methods for generating and implementing software components that contain or are based on the program codes processed by the methods of the present invention.

FIG. 2 schematically shows methods for generating a dictionary, according to an example embodiment of the present invention.

FIG. 3 schematically shows methods for training a machine learning model to edit program code according to an example embodiment of the present invention.

### DETAILED DESCRIPTION OF EXAMPLE EMBODIMENTS

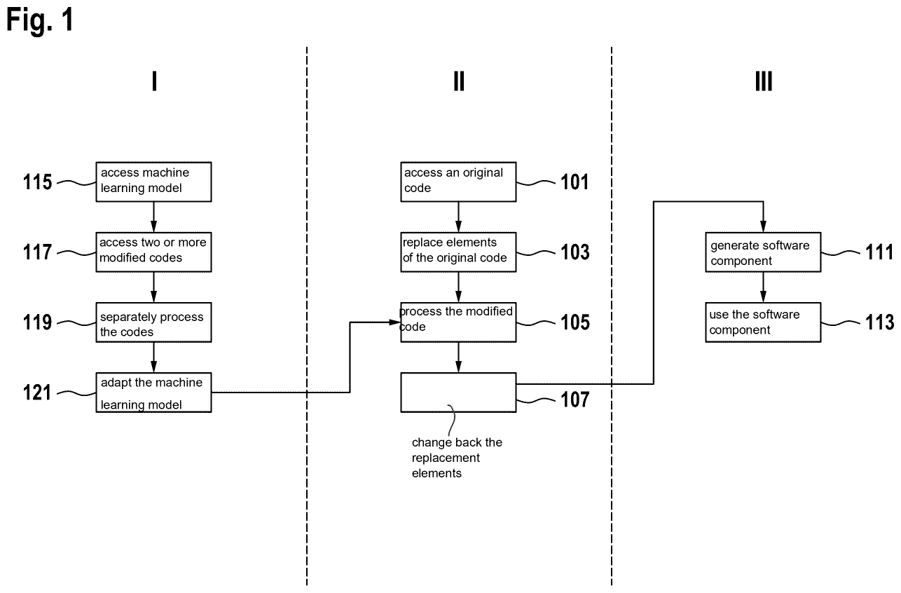

FIG. 1 illustrates methods of the present invention. In the middle column (II), a flowchart of a method for editing program code by means of a machine learning model according to the present invention is shown.

The method for editing program code by means of a machine learning model comprises accessing 101 an original code. The original code can be any program code or a part or portion of a program code. In some examples, the original code can define a closed software component (e.g., a software component of a control unit of the software components described below). In other examples, the original code can be a subunit of a closed software component (e.g., a method or a function). In still other examples, the original code can be a part of the software components described above. The original code can be written in a specific programming language (i.e., a formal language for formulating data structures and algorithms, i.e., computational rules that can be executed by a computing unit). The original code can be written in a higher programming language, but also in a machine language. In other examples (or in addition), the original code can be written in a human-readable description (e.g., a code that is not used for machine interpretation but merely for illustration). The original code can contain machine-interpretable elements, but also metadata (e.g. annotations).

In some examples, the original code can be machine-generated.

The method further comprises replacing 103 elements of the original code with replacement elements to obtain a modified code. The replacement elements are shorter than the corresponding elements of the original code.

In some examples, the replacement elements have fewer symbols than the corresponding elements of the original code. Additionally or alternatively, at least parts of the elements of the original code (i.e., some or all) can be identifiers (e.g., names) for components of the original code. The identifiers can in particular refer to variables, functions, methods and/or classes of the original code.

A symbol can be any element present in the original code, wherein at least some syntax elements of the original code are designated by identifiers consisting of multiple symbols. The symbols can, for example, be single characters (e.g. letters, numbers and/or special characters) or can be composed of multiple characters (e.g. letters, numbers and/or special characters). Additionally or alternatively, the symbols can be syllables or groups of syllables. Further additionally or alternatively, the symbols can be words or expressions consisting of multiple words.

In some examples, the type of symbol can be determined by the machine learning model with which the modified code is to be processed. For example, certain machine learning models can receive inputs in which the requests to the machine learning model are decomposed (parsed) into elements in a specific way. Each of the individual elements is then fed (possibly after one or more preprocessing steps) to a different input of the machine learning model. In other examples, the individual elements are fed in sequentially. In some examples, the symbols can be tokens of a machine learning model (e.g., a generative language model, e.g., a large language model).

Depending on the type of symbols, the length of the replacement elements can vary (and consequently also the rule according to which it is determined whether one (replacement) element is shorter than another). For example, a length can refer to a number of characters (e.g., letters, numbers, and/or special characters), a number of syllables, or a number of tokens (i.e., input elements of a machine learning model).

The step of replacing 103 elements of the original code with replacement elements can, in some examples, comprise one or more of the following further steps or aspects.

In some examples, all elements of the original code are replaced by corresponding replacement elements. In other examples, only some of the elements of the original code can be replaced by corresponding replacement elements. For example, only elements that have a certain minimum length (e.g. measured in a number of symbols, e.g. three symbols or more) can be replaced. Additionally or alternatively, elements can be replaced by corresponding replacement elements only in certain parts of the original code. Further additionally or alternatively, elements can be replaced by corresponding replacement elements only until the original code has reached a certain minimum length.

In some examples, certain elements of the original code cannot be replaced (e.g., instructions in a programming language in which the original code is written).

A short example is introduced below for illustration. In this example, the original code is written in the C programming language. One line of code reads as follows:

$$rbg\_VcuWiperCtrl . rbg\_VSSWiperCtrl \_stT15Car = ( ( rbg\_VcuWiperCtrl . rbg\_VSSWiperCtrl \_flgCANTestReq ) \text{??} rbg\_VcuWiperCtrl . rbg\_VSSWiperCtrl \_stCarT15tCarTest \_C : ( ( ( Rte\_DRead \_RP \_Com \_Car \_To \_VCU \_flgT15On \_rba \_Nds \_Swc \_VDP \_Car \_To \_VCU \_flgT15On ( ) ) ? 1 U : 0 U ) ) ) ;$$

It can be seen that the code contains very long identifiers. These elements can now be replaced by corresponding replacement elements:

$$b . bt = ( ( b . ee ) ? b . en : ( ( ( em ( ) ) ? 1 U : 0 U ) ) ) ;$$

For example, the identifier for a field of a variable “rbg_VcuWiperCtrl.rbg_VSSWiperCtrl_stT15Car” has been replaced by the identifier “b.bt”. This consists of considerably fewer letters or tokens, for example.

The method further comprises processing 105 the modified code by means of a machine learning model. The processing can comprise any techniques used to change, enhance or transform the (modified) code. The processing 105 generates a processed modified code (the processed modified code can still comprise one or more of the replacement elements).

In some examples, the processing of the modified code by a machine learning model can comprise incorporating at least a part of the modified code into a request to the machine learning model. For example, the modified code can be incorporated into a request (e.g., a prompt) of a generative language model.

In some examples, the processing comprises translating the modified code from a first programming language into a second programming language. In these examples, the machine learning model can be a machine learning model trained to translate code from the first programming language into the second programming language (e.g. a generative language model, for example a large language model).

Additionally or alternatively, processing can comprise changing the modified code according to a predetermined target criterion. In these examples, the machine learning model can be a machine learning model trained to improve code with respect to the target criterion (e.g., a generative language model, e.g., a large language model). The target criterion can be, for example, the removal of errors from the modified code. In this case, the processing can comprise removing errors from the modified code. Additionally or alternatively, the target criterion can comprise optimizing the modified code (e.g., improving a performance of the modified code with respect to a task, reducing a resource requirement of the modified code, adapting the modified code to a format specification, and/or other optimizations). In this case, the processing can comprise optimizing the modified code.

Further additionally or alternatively, the processing of the modified code can comprise converting the modified code from an adaptation to a first execution environment (e.g., a first hardware platform) to an adaptation to a second execution environment (e.g., a second hardware platform). In these examples, the machine learning model can be a machine learning model (e.g., a generative language model, e.g., a large language model) trained to convert code from an adaptation to a first execution environment (e.g., a first hardware platform) to an adaptation to a second execution environment (e.g., a second hardware platform). For example, the modified code can be adapted to a first type of computing device (e.g., a microcontroller, a processor, a backend system, a cloud system, an edge system) and by the processing for execution on a second type of computing device that is different from the first type of computing device (e.g., a microcontroller, a processor, a backend system, a cloud system, an edge system).

Further additionally or alternatively, the processing of the modified code can comprise annotating or explaining the modified code. In these examples, the machine learning model can be a machine learning model trained to annotate or explain code (e.g., a generative language model, e.g., a large language model).

The machine learning model used for the processing can be any suitable machine learning model (e.g. a machine learning model that includes one or more neural networks). In some examples, the machine learning model is a generative machine learning model, e.g., a generative foundation model. In some examples, the machine learning model can comprise a language model or a model for language generation. For example, the machine learning model can comprise a large language model. The machine learning model can be based on an existing (trained) generative machine learning model and adjusted (e.g., by further training and/or fine-tuning) with one or more of the techniques described below for use in the methods of the present disclosure. For example, the generative machine learning model can comprise one or more of CodeLlama, Llama, Mistral, CoPilot and/or language models from the GPT family (for example, ChatGPT). In other examples, multi-modal models such as Gemini, GPT4o can be used.

In the small example introduced above, the introduced line of code can be translated from the C programming language to the Rust programming language by a machine learning model:

$$b . bt = if b . ee \{ b . en \} else \{ if em ( ) \{ 1 \} else \{ 0 \} \} ;$$

In some examples, the method further comprises changing back 107 the replacement elements to the elements of the original code in the modified code. In other words, a modification introduced by the replacing step 103 is undone in the processed modified code. This step of changing back 107 can generate a processed code (i.e., an unmodified code or also processed original code). The processed code can again contain the identifiers, symbols or other elements of the original code. In other words, the processed code can look as if the original code had been processed by means of the machine learning model, even though it was not the original code itself that was processed, but the modified code (and the original code might not even be processable with the machine learning model). This allows the possible uses of the machine learning model to be expanded.

In the example already mentioned, the processed modified code in the Rust programming language is converted into processed code by changing back the replacement elements: PGP-24E

$$rbg\_VcuWiperCtrl . rbg\_VSSWiperCtrl \_stT15Car = if rbg\_VcuWiperCtrl . rbg\_VSSWiperCtrl \_flgCANTestReq \{ rbg\_VcuWiperCtrl . rbg\_VSSWiperCtrl \_stCarT15CarTest \_C \} else \{ if Rte\_DRead \_RP \_Com \_Car \_To \_VCU \_flgT15On \_rba \_Nds \_Swc \_VDP \_Car \_To \_VCU \_flgT15On ( ) \{ 1 \} else \{ 0 \} \} ;$$

In some examples, replacing elements of the original code with replacement elements and/or changing back the replacement elements to the elements of the original code can comprise using a dictionary that specifies how the replacement elements correspond to the elements of the original code. For example, the dictionary can comprise a one-to-one assignment of a plurality of elements to a plurality of replacement elements (in any suitable data structure, for example a database). Replacing can then comprise retrieving from the dictionary a replacement element for a particular element in the original code. Accordingly, changing back can comprise retrieving from the dictionary an element for a particular replacement element in the processed modified code.

In other examples, replacing elements of the original code with replacement elements and/or changing back the replacement elements to the elements of the original code can comprise using a rule-based algorithm. For example, the step can comprise using a replacing or changing back function. The replacing or changing back function can be a bijective function that assigns elements to replacement elements one-to-one (and at the same time causes a shortening of the length of the replacement elements in comparison with the elements). The changing back function can be an inverse of the replacing function (i.e., an application of the replacing function followed by the application of the changing back function represents an identity operation). For example, the replacing function can comprise lossless compression of the element to generate the replacement element. Additionally or alternatively, the replacing function can comprise a coding function (e.g., entropy coding). The replacing or changing back function can be in any possible format (e.g. as a computer program or as a function of a computer program).

In some examples, the methods of the present disclosure comprise generating a dictionary (for the described replacing or changing-back steps). In some examples, the generation can take place in parallel with the step of replacing elements. In other examples, the generation of the dictionary can be performed before the steps of replacing elements in an original code (i.e., a dictionary is present at the beginning of the replacing steps and/or was created using different original code than the original code present specifically for processing). In still other examples, an existing dictionary can be extended and/or supplemented during the step of replacing elements (e.g., by new pairs of elements and replacement elements).

In other examples, the methods of the present disclosure comprise generating a rule-based algorithm (e.g., a bijective function) that converts an element into a replacement element and vice versa (for the described replacing or changing-back steps). For example, the replacing function can comprise lossless compression of the element to generate the replacement element. Additionally or alternatively, the replacing function can comprise a coding function (e.g., entropy coding).

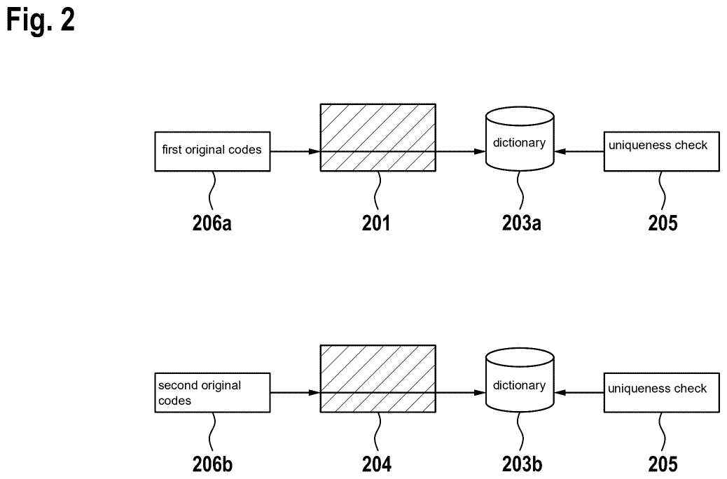

FIG. 2 schematically shows methods 200 for generating a dictionary of the present disclosure.

In some examples, the generation of a dictionary 203a can be performed by a rule-based algorithm 201 (e.g., one of the rule-based algorithms described above from one or more first original codes 206a). For example, the corresponding replacement elements can be formed by means of one or more heuristic rules from the elements (or one or more of the above-mentioned symbols that form the elements).

In other examples, the dictionary can be implemented by means of a further machine learning model 204 for generating a dictionary 203b (from one or more second original codes 206b). The further machine learning model 204 can be trained to generate a corresponding unique replacement element for an element. In some examples, the replacement element can contain an identifier that humans can understand (e.g., an identifier of an object, class, variable, function, or method). In this case, the further machine learning model 204 can be trained to generate replacement elements with or from identifiers that humans can understand. In order to do this, the further machine learning model 204 can analyze the context of the element in question.

In any case, the method for generating the dictionary can comprise a uniqueness check 205. This can comprise comparing all entries in the dictionary with one another to determine whether an entry has been assigned twice. In this case, one (or both) of the entries that have been assigned twice can be changed.

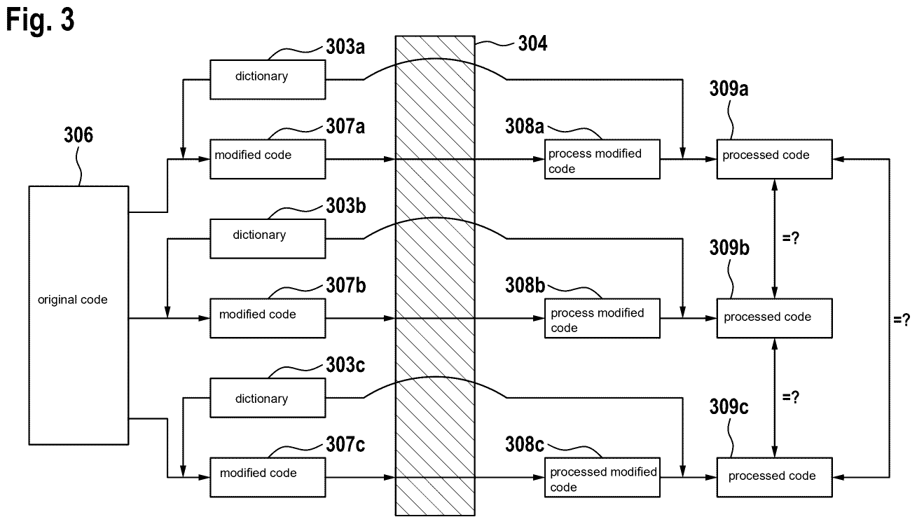

The present disclosure also relates to a method for training a machine learning model to edit program code. The left-hand column of FIG. 1 (I) shows a flowchart of a method for training a machine learning model to edit program code according to the present disclosure. FIG. 3 schematically shows methods for training a machine learning model to edit program code according to the present disclosure.

The method for training a machine learning model to edit program code comprises accessing 115 a machine learning model 304. The machine learning model 304 can be trained for one of the processing tasks described above.

The method for training a machine learning model comprises accessing 117 two or more modified codes 307a, 307b, 307c (e.g., more than two or more than five modified codes). Each modified code 307a, 307b, 307c is generated from an original code 306 by replacing elements of the original code 306 with replacement elements. The replacement elements are shorter than the corresponding elements of the original code. The replacement elements for each of the modified codes differ from one another at least partially. In other words, the replacement elements are selected differently for each of the two or more modified codes (i.e., the same original code 306 is modified in two or more different ways).

In some examples, the method comprises replacing elements of the original code 306 with various replacement elements to obtain the two or more modified codes 307a, 307b, 307c (e.g., by means of the techniques for replacing elements described above). The two or more modified codes 307a, 307b, 307c can differ in various ways, e.g., different dictionaries 303a, 303b, 303c and/or different rule-based algorithms can be used to select the replacement elements.

The method for training a machine learning model to edit program code further comprises separately processing 119 the two or more modified codes 307a, 307b, 307c by the machine learning model 304. In other words, each modified code 307a, 307b, 307c can be processed independently of the further modified codes 307a, 307b, 307c by the machine learning model 304 (to generate two or more associated processed modified codes 308a, 308b, 308c).

The method for training a machine learning model to edit program code further comprises adapting 121 the machine learning model 304 on the basis of an analysis of a result of the processing of the two or more modified codes 307a, 307b, 307c. For example, an objective of the adaptation 121 can be independence from the replacement elements of the modified codes. In other words, the machine learning model 304 is to be modified such that a processing result of the machine learning model 304 is independent of the way in which the specific replacement elements are selected (e.g., the specific dictionary and/or the specific rule-based algorithm). The machine learning model 304 can then be invariant to a change in the dictionary and/or the specific rule-based algorithm used for the replacement steps.

In some examples, the analysis comprises comparing the results of the separate processing of the two or more modified codes 307a, 307b, 307c and adapting the machine learning model 304 on the basis of a result of the comparison. For example, in the two or more processed modified codes 308a, 308b, 308c, the replacement elements can each be changed back to the corresponding elements (e.g., with the help of the specific dictionaries 303a, 303b, 303c and/or the specific rule-based algorithms). Two or more processed codes 309a, 309b, 309 can be generated as a result. The comparison can now include checking whether the two or more processed codes 309a, 309b, 309 are the same or at least similar (under a predetermined similarity measure). Depending on a result of the comparison, the machine learning model 304 (e.g., its parameters) can then be adapted in order to establish or increase identity or similarity of the processed codes generated thereby.

The identity or similarity can be assessed by checking the functional equivalence of the processed codes 309a, 309b, 309 (i.e., the processed codes 309a, 309b, 309 exhibit an identical or similar function). The functional equivalence can be assessed, for example, by tests of the processed codes 309a, 309b, 309, by model checking methods with the processed codes 309a, 309b, 309 or by fuzzing the processed codes 309a, 309b, 309.

In some examples, the adaptation is performed by unsupervised training of the machine learning model 304 (e.g., on the basis of the comparisons described above, from which a loss function for training the machine learning model 304 can be created).

The right-hand column of FIG. 1 (III) shows a flowchart of methods for generating (111) and implementing software components that contain or are based on the program codes processed by the methods of the present disclosure.

The methods of the present disclosure can generally be carried out within the framework of a software development process (e.g., software for a specific technical system, for example a control unit).

The present disclosure also relates to carrying out one of the methods for editing program code by means of a machine learning model of the present disclosure and generating a software component that contains the edited program code or is based on the edited program code. Generating can comprise one or more steps to make the edited program code into an executable software component (e.g., compilation). In other cases, generating can produce a software component that still needs to be converted into an executable software component.

The method can further comprise implementing the software component (e.g., a run-capable software component) in a system. Depending on the type of system, the implementation can include creating an instance of the system, installing the software component to generate an instance of the system, or similar implementation steps. For example, a software component can be installed on a computing unit. Specific software components and systems are described below.

The present disclosure also relates to an environment that is designed to carry out one of the methods of the present disclosure. In some examples, the environment can be a development environment for program code.

The present disclosure also relates to a method of using 113 a software component or a system containing the software component that contains the program code edited using the techniques of the present disclosure or is based on the edited program code.

In examples, the software component or a system containing the software component (e.g., a control unit) can be designed for closed-loop control and/or open-loop control and/or monitoring of a technical system.

In examples, the method can comprise using the software component or the system containing the software component for open-loop control, closed-loop control and/or monitoring of a vehicle function, a robot function, a building automation function, a power tool automation function, and/or a home appliance automation function.

In one example, the software component or a system containing the software component can be designed to be arranged in a vehicle and/or designed to control a vehicle function (in particular to control a driving function). For example, the vehicle function can be a function for autonomous and/or assisted driving. In some examples, the software component or a system containing the software component can be designed to be executed on a computer system of a vehicle (for example an autonomous, highly automated or assisted driving vehicle). For example, the computer system can be implemented locally in the vehicle or (at least partially) in a backend that is communicatively connected to the vehicle. For example, a system containing the software component can comprise or be a control unit. In some examples, the vehicle can comprise a computer system with a communication interface which allows communication with a backend. For example, the software component can be executed in this backend. In one example, the particular system can be a system for transverse guidance and/or longitudinal guidance of the vehicle. In examples, the software component or a system containing the software component can receive speed information or distance information as input data. Alternatively or additionally, the input data can comprise a relative velocity and/or a distance between a first vehicle, a second vehicle, a person and/or a stationary object. Alternatively or additionally, the input data can comprise variables based at least on one of a steering angle, an orientation angle, a yaw rate, a slip angle, and/or a lateral error. Alternatively or additionally, the input data can comprise information from a network, such as motion information and/or direction information from other vehicles. In examples, this information can be provided by means of vehicle-to-vehicle communication (V2V communication) or by means of a backend (V2X communication). Alternatively or additionally, the input data can comprise a steering velocity or target specifications for acceleration processes and/or braking processes.

In examples, the software component or a system containing the software component can be designed to be arranged in a drive controller or a drive unit and/or can be used for closed-loop control of a motor-related function (in particular for closed-loop motor control). In examples, the software component or a system containing the software component can be arranged for arrangement in a closed-loop drive control system of an electrical machine. For example, the state vector of the state space model can contain variables based on at least one of a control signal, an operating mode or a power setting of the electric machine.

The present disclosure also relates to the use of the software component or a system containing the software component for open-loop control and/or closed-loop control and/or monitoring of a robot.

In other examples, the software component or a system containing the software component can be arranged in a robot and/or can be designed for open-loop control of a robot function (in particular for open-loop control of a movement function of a robot). For example, the software component or a system containing the software component can be a system for lateral guidance and/or longitudinal guidance of the robot. In some examples, the software component or a system containing the software component can be executed on a computer system of a robot. For example, the computer system can be locally implemented in the robot or (at least partially) in a backend that is communicatively connected to the robot. In some examples, the software component or a system containing the software component can be executed in a backend. In examples, the software component or a system containing the software component can obtain speed information or distance information as input data. Alternatively or additionally, the input data can comprise a relative velocity and/or a distance between a first robot, a person, a further mobile device and/or a stationary object. Alternatively or additionally, the input data can comprise variables based at least on one of a steering angle, an orientation angle, a yaw rate, a slip angle, and/or a lateral error. Alternatively or additionally, the input data can comprise information from a network, such as motion information and/or direction information from other robots, mobile devices and/or people. In examples, this information can be provided by means of direct communication or by means of a backend. In one example, an input vector can comprise a steering velocity or target specifications for acceleration processes and/or braking processes.

The present disclosure also relates to the use of a software component or a system containing the software component for open-loop control and/or closed-loop control and/or monitoring of functions in building automation.

In one example, the software component or a system containing the software component can be designed for arrangement in a building and/or for open-loop control and/or closed-loop control and/or monitoring of building functions (in particular for open-loop control and/or closed-loop control of building automation functions). For example, the building function can be a function for controlling room temperature, lighting, and/or safety equipment by means of closed-loop control.

The techniques of the present disclosure can, in some examples, be executed automatedly.

Also disclosed is a computer system that is designed to carry out the methods for editing program code by means of a machine learning model according to the present disclosure.

Alternatively or additionally, the computer system can be designed to carry out the methods for training a machine learning model to edit program code according to the present disclosure. The computer system can comprise a processor and/or a working memory. The computer system can be network-based and/or distributed. For example, the steps of processing the modified code can be carried out on a remote server (which can in turn be a distributed system).

Further disclosed is a computer program containing instructions that, when executed by a computer system, cause the computer system to carry out the methods for editing program code by means of a machine learning model according to the present disclosure. Alternatively or additionally, the computer program can contain instructions that, when executed by a computer system, cause the computer system to carry out the methods for training a machine learning model to edit program code according to the present disclosure. The computer program can be present, for example, in interpretable or in compiled form. For execution, it can (even in portions) be loaded into the RAM of a computer, e.g., as a bit or byte sequence.

1-14. (canceled)

15. A method for editing program code using a machine learning model, the method comprising the following steps:
accessing an original code;
replacing elements of the original code with replacement elements to obtain a modified code, wherein the replacement elements are shorter than the corresponding elements of the original code; and
processing the modified code using a machine learning model.

16. The method according to claim 15, further comprising the following steps:
changing back the replacement elements to the elements of the original code in the modified code.

17. The method according to claim 15, wherein the machine learning model is a large language model.

18. The method according to claim 15, wherein the replacement elements have fewer symbols than the elements of the original code they replace, wherein the symbols are tokens of the machine learning model.

19. The method according to claim 15, wherein at least parts of the elements of the original code are identifiers for components of the original code including identifiers of objects, and/or variables, and/or functions, and/or methods and/or classes.

20. The method according to claim 15, wherein the processing of the modified code includes one or more of:
translating the modified code from a first programming language into a second programming language;
changing the modified code according to a predetermined target criterion;
converting the modified code from an adaptation to a first execution environment to an adaptation to a second execution environment, and/or
annotating or explaining the modified code.

21. The method according to claim 15, wherein the processing of the modified code using the machine learning model includes incorporating at least a part of the modified code into a request to the machine learning model.

22. The method according to claim 16, wherein the replacing of the elements of the original code with the replacement elements and/or changing back the replacement elements to the elements of the original code includes using a dictionary that specifies how the replacement elements correspond to the elements of the original code.

23. The method according to claim 22, further comprising:
generating the dictionary, wherein the dictionary is implemented using a further machine learning model for generating a dictionary.

24. A method for training a machine learning model to edit program code, comprising the following steps:
accessing a machine learning model;
accessing two or more modified codes, wherein each modified code is generated from the same original code by replacing elements of the original code with replacement elements, wherein the replacement elements are shorter than the corresponding elements of the original code, and wherein the replacement elements for each of the modified codes differ from one another at least partially;
separately processing the two or more modified codes using a machine learning model; and
adapting the machine learning model based on an analysis of a result of the processing of the two or more modified codes by the machine learning model.

25. The method according to claim 24, wherein the analysis includes comparing results of the separate processing of the two or more modified codes, and wherein the adaptation includes adapting the machine learning model on the basis of a result of the comparison.

26. The method according to claim 25, wherein an objective of the adaptation is independence of the processing from the replacement elements of the modified codes.

27. An environment that is configured to carry out a method for editing program code using a machine learning model, the method comprising the following steps:
accessing an original code;
replacing elements of the original code with replacement elements to obtain a modified code, wherein the replacement elements are shorter than the corresponding elements of the original code; and
processing the modified code using a machine learning model.

28. A non-transitory computer-readable medium on which is stored a computer program containing instructions editing program code using a machine learning model, the instructions, when executed by a computer, causing the computer to perform the following steps comprising:
accessing an original code;
replacing elements of the original code with replacement elements to obtain a modified code, wherein the replacement elements are shorter than the corresponding elements of the original code; and
processing the modified code using a machine learning model.
